(19) United States
(12) Patent Application Publication
(10) Pub. No.: US 2005/0247530 A1
(43) Pub. Date: Nov. 10, 2005

(54) Disposition on disk brake pads

(76) Inventor: Marcelo Laterza Lopes, Indaiatuba (BR)

Correspondence Address: KELLEY DRYE & WARREN LLP, TWO STAMFORD PLAZA, 281 TRESSER BOULEVARD, STAMFORD, CT, 06901, US

(21) Appl. No.: 10/519,927

(22) PCT Filed: Dec. 11, 2002
(86) PCT No.: PCT/BR02/00182

§ 371 Date: Dec. 30, 2004

(30) Foreign Application Priority Data
Jul. 1, 2002 (BR) MU 8201580-5

(51) Int. Cl. F16D 65/04

(52) U.S. Cl. 188/250 E

(57) ABSTRACT

Characterized for the related pad of the disk brakes to have configured on its friction surface, on all its area, a plurality of small projections orderly disposed on parallel rows that cross in two ways and leveled to the surface level of the pad, being possible those small projections have several shapes (circle, triangle, polygon, oblong, etc.).

This present patent concerns on the Model of Disposition Utility on Disk Brake Pads, which is characterized for revealing on the friction surface a plurality of small projections orderly disposed on parallel rows crossed in two ways, being possible those small projections have several shapes (square, circle, triangle, polygon, etc).

The presence of those small projections on the friction surface of the pads aims to avoid the excessive heating of the brakes, dissipating the heat more quickly, to contribute in order the water be also expelled more quickly, to eliminate gases and, finally, to provide a good braking, with more efficiency and safety, preventing the temporary alterations in the friction properties of the material used on the pad, which normally happen with the conventional pads.

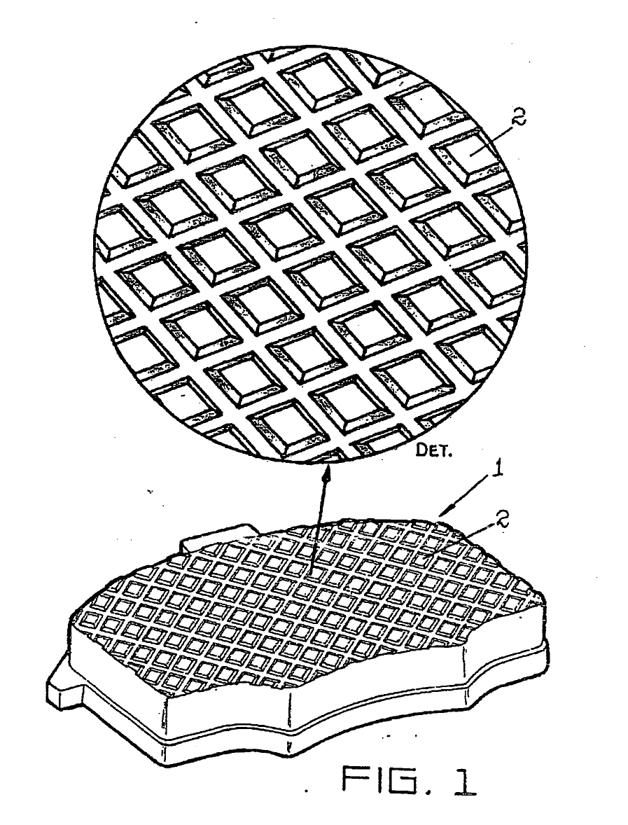

In order to have a clear visualization of the brake disk pads with the new disposition applied, there is a picture attached, whose single illustration (FIG. 1) represents the view in perspective of a pads with the innovation, object of the patent, showing in detail the plurality of small projections present on the friction surface.

As it can be inferred from this illustration, the pads (1) of the brake disks, herein proposed, is characterized essentially for having configured on its friction surface, on all its area, a plurality of small projections (2) orderly disposed on parallel rows that cross in two ways, and leveled to the surface plane of the referred pad.

The figurative disposition of those small projections, represented on the illustration, has the shape of frustum of pyramid, being possible, however, to have other shapes, such as: circle, triangle, polygon, oblong, etc., but without diminishing or jeopardizing the scope or finality of the present pad.

Thus, the present Disposition on Disk Brake Pad meets completely the aims proposed, fulfilling in a practical and efficient way the function to which it is done, providing a series of advantages and benefits inherent to its applicability, having its own characteristics which are innovative and endowed with fundamental requirements of novelty.

1. “DISPOSITION ON DISK BRAKE PADS”, characterized for the pad (1) of the disk brakes to have configured on its friction surface, on all its area, a plurality of small projections (2) orderly disposed on parallel rows that cross in two ways and leveled to the surface level of the referred pad.
